(19) United States
(12) Patent Application Publication
(10) Pub. No.: US 2005/0038677 A1
(43) Pub. Date: Feb. 17, 2005

(54) Cooperative health care plan and method thereof

(76) Inventor: Nicholas Hahalis, Marietta, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/897,841

(22) Filed: Jul. 23, 2004

Related U.S. Application Data
(60) Provisional application No. 60/495,264, filed on Aug. 15, 2003.

(51) Int. Cl. G06F 17/60

(52) U.S. Cl. 705/2

(57) ABSTRACT

A cooperative health care plan and method thereof, wherein a true capitation system for both clinic and hospital care enables individual members to receive preventative and curative care at a low cost while providing an income stream for municipal hospitals.

### CROSS-REFERENCE TO RELATED APPLICATIONS

To the full extent permitted by law, the present application claims priority to and the benefit as a non-provisional application to provisional patent application entitled “Cooperative Health Care Plan and Method Thereof” filed on Aug. 15, 2003, having assigned Ser. No. 60/495,264, wherein said application is incorporated herein by reference.

### TECHNICAL FIELD

The present invention relates generally to health care plans and, more specifically, to a cooperative health care plan and method wherein a true capitation system for both clinic and hospital care enables individual members to receive preventative and curative care at a low cost while also providing an income stream for municipal hospitals.

### BACKGROUND OF THE INVENTION

Medical care, especially in emergency and catastrophic situations, is very costly. Group health insurance plans are relied upon by a large proportion of individuals and families to provide coverage for such unexpected expenses. Typically, the insurer accepts responsibility for at least a large percentage of the bills from the treating facility.

Coverage under indemnity, or fee-for-service plans, generally allows total choice regarding physician or treatment center, and, as a result, are the plans with the most expensive premiums. Coverage under managed care plans, however, can offer a range of options. Preferred Provider Organization (PPO) plans typically enable an individual to choose any location for treatment, but provide greater coverage for treatment sought from a preferred provider or treatment center. Additionally, although coverage under a Health Maintenance Organization (HMO) plan is typically restrictive as to choice, such plans often offer lower premiums and fewer out-of-pocket expenses. Moreover, an HMO will usually only cover treatment provided by authorized HMO caregivers.

For the hundreds of thousands of individuals who are unable to afford health insurance premiums, and who do not receive such benefits from the workplace, healthcare needs often remain unmet. For those able to qualify for governmental aid, treatment is usually provided at county teaching hospitals, wherein the facility receives reimbursement for services via the appropriate governmental program. Many individuals remain, however, who are uninsured and unable to qualify for governmental health care assistance. This unfortunate segment of the population falls into a gap in the present system of coverage and healthcare.

As a result, most such individuals forego most, or all, routine or preventative health care. Moreover, in the event of an emergency or catastrophic illness, many private treatment facilities will not admit such a patient. Treatment for such individuals can usually only be obtained at a government-funded county teaching hospital, wherein the provision of services for the sick and/or injured is legally mandated. As a result, although medical treatment must be administered, payment for the services is largely unmet. Governmental stipends to such facilities are often inadequate in the face of the mounting uninsured, wherein each such individual can often accumulate a hospital debt of potentially tens, or even hundreds, of thousands of dollars. Although some are willing and able to make ongoing payments over an extended period of time to repay the debt, many default, and may even be led into bankruptcy. Unfortunately, in the majority of cases, it is the care facility that must absorb the disparity between the monies received from all sources and the ever-increasing expense of treatment. As a result, many public treatment facilities have been forced to close and/or to declare bankruptcy, creating an even larger strain on those remaining facilities, forced to care for the ever-increasing population of the uninsured.

Therefore, it is readily apparent that there is a need for a method for enabling uninsured individuals, including those unable to qualify for governmental medical assistance, to receive health care and, at the same time, compensate the treatment facilities providing such care, thus preventing the above-discussed disadvantages.

### BRIEF SUMMARY OF THE INVENTION

Briefly described, in a preferred embodiment, the present invention overcomes the above-mentioned disadvantages, and meets the recognized need for such a system and method, by providing a cooperative health care plan and method thereof, wherein a true capitation system for both clinic and hospital care enables individual members to receive preventative and curative care at a low cost while providing an income stream for municipal hospitals.

According to its major aspects and broadly stated, the present invention is a method for enabling uninsured individuals, including those unable to qualify for governmental medical assistance, to receive health care and, at the same time, compensate the treatment facilities providing such care.

More specifically, the present invention is a system and method of providing a health care plan to individuals otherwise unable or unwilling to participate in traditional health insurance coverage and/or government assisted plans, and for providing a source of income for municipal teaching hospitals and clinics. In the preferred embodiment of the present invention, individuals may obtain membership in the healthcare plan in return for a relatively small monthly fee, wherein each member receives an identification card enabling the receipt of health care services from a selected municipal teaching hospital, clinic, pharmacy, and/or the like.

A participating municipal clinic and/or pharmacy receives a monthly fee for each individual member of the plan, and, in return, agrees to provide prescriptions and/or outpatient care, as supported by the in-facility equipment and capabilities, with little or no out-of-pocket cost to the member. A participating municipal teaching hospital receives a monthly fee for each individual member of the plan that has agreed to receive hospital care only from that hospital. That is, each member agrees to seek and have coverage provided with respect to only one municipal teaching hospital, wherein the hospital, in return, receives a monthly stipend for each such member. Through participation in the present cooperative health insurance plan, the municipal teaching hospital agrees to provide treatment to members at little or no cost to the member, and, instead, relies upon the monthly fees for ongoing financial security.

Each type of participant of the present system and method appreciates a variety of benefits. First, the individual members benefit immediately by receiving the peace-of-mind in knowing that their health care needs will be met without potentially catastrophic financial consequences. Additionally, each individual member is afforded long-term benefits by receiving preventative and routine medical care, and by avoiding ongoing financial/credit strains from unnecessary debt. Second, health treatment providers, especially municipal teaching hospitals, benefit immediately by receiving a generally steady stream of monthly income without a resulting increase in staff. That is, such hospitals would likely have had to treat the same individuals, often without any source of compensation therefor. Additionally, society appreciates a tremendous long-term benefit by realizing a healthier population and a stronger and more plentiful health care network of services.

Accordingly, a feature and advantage of the present invention is the ability of such a method to encourage preventative health care measures to be undertaken by individuals previously unable to pursue such check-ups, treatments and routine screening tests.

A feature and advantage of the present invention is the ability of such a method to enable cooperation between a variety of health care organizations, wherein each mutually benefits therefrom.

A feature and advantage of the present invention is the ability of such a method to provide health care facility financial incentives, wherein membership tallies are utilized for calculation thereof.

A feature and advantage of the present invention is the ability of such a method to reduce the number of bad debts generated from the treatment of uninsured individuals, and provide a positive and generally consistent income stream.

A feature and advantage of the present invention is the ability of such a method to reduce the number of printed bills and statements produced by a health care clinic, hospital and/or pharmacy, and provide a format for increasing gross revenue.

A feature and advantage of the present invention is the ability of such a method to provide an immediate reduction in paper billing and collection costs for participating health care organizations.

A feature and advantage of the present invention is the ability of a participating health care organization to receive compensation for the commitment to provide particular services to particular member individuals.

A feature and advantage of the present invention is the ability of such a method to improve the overall health condition of society by providing all individuals with access to health care.

A feature and advantage of the present invention is the ability of such a method to provide participating health care organizations with long-term advantages, such as, for exemplary purposes only, a reduction in unpaid patient invoices and improved budget planning capabilities.

A feature and advantage of the present invention is the ability of such a method to provide a teaching hospital with a means to provide a diverse experience to staff interns and doctors.

A feature and advantage of the present invention is the ability of such a method to enable a participating health care facility and/or pharmacy to easily monitor and/or measure the beneficial success of participation in the plan.

A feature and advantage of the present invention is the ability of such a method to enable a participating hospital to receive per person compensation for agreeing to treat individuals who would likely have been treated thereby anyway, but, who would likely have not provided any type of financial recompense for such treatment.

These and other features and advantages of the invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a flowchart of a system and method for providing health care services according to a preferred embodiment of the present invention, wherein the relationship of the participants is depicted.

FIG. 2 is a flowchart of a system and method for providing health care services according to a preferred embodiment of the present invention, showing the functionality of the administrator thereunder.

FIG. 3 is a flowchart of a system and method for providing health care services according to a preferred embodiment of the present invention, showing the procedure for a member seeking health care services thereunder.

FIG. 4 is a table of a system and method for providing health care services according to a preferred embodiment of the present invention, showing an example financial breakdown for a fictitious city.

### DETAILED DESCRIPTION OF THE PREFERRED AND ALTERNATE EMBODIMENTS

In describing the preferred and alternate embodiments of the present invention, as illustrated in the figures, specific terminology is employed for the sake of clarity. The invention, however, is not intended to be limited to the specific terminology so selected, and it is to be understood that each specific element includes all technical equivalents that operate in a similar manner to accomplish similar functions.

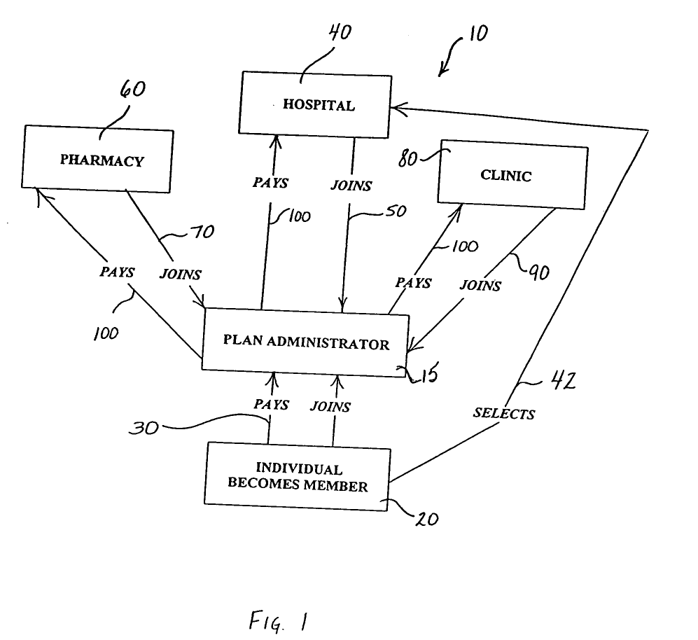

Referring now to FIG. 1, the present invention in a preferred embodiment is a system and method of providing health care services 10 to a plurality of individual members 20 in exchange for a predetermined monthly fee 30, wherein member hospital 40 offers treatment 50, member pharmacy 60 offers prescription services 70, and member clinic 80 offers available care 90, and, in return, each member hospital 40, member pharmacy 60 and member clinic 80 receive a predetermined monthly stipend 100. Member hospital 40, member pharmacy 60 and member clinic 80 are illustrated for purposes of clarity, however, it is within the contemplation of the inventor that the present system and method could, and preferably would, harness a plurality of such members.

One skilled in the art would readily recognize that, while a monthly fee 30 and a monthly stipend 100 are preferred, other payment and compensation periods could be utilized without deviating from the intended focus of the present system and method. For example, monthly fee 30 could alternately be collected, and/or monthly stipend could be distributed, at weekly, biweekly, quarterly, semi-annual or annual intervals.

Preferably, each member hospital 40 is a municipal hospital, such as a city, county or other type of public facility. Additionally, each member hospital 40 is preferably a teaching hospital. Teaching hospitals are typically staffed with newly trained and/or training physicians, wherein the doctors are paid a salary, and their services billed through the hospital. Such physicians provide care for any and all patients without regard for financial solvency, and generally seek broad experience to build their knowledge base. Thus, participation in the present system and method of providing health care services 10 can be beneficial to the typical neophyte doctor. Although the present system and method of providing health care services 10 is particularly well-suited for application by municipal teaching hospitals, it is contemplated and expected that other types of facilities could also benefit therefrom. Thus, member hospital 40 could also be a private hospital and/or a non-teaching facility, wherein the other aspects of the plan could remain the same.

In the preferred embodiment of the present invention, each individual of the plurality of individual members 20 obtains membership by agreeing to pay monthly fee 30. Monthly fee 30 can be any amount, but is preferably minimized relative to current health insurance premiums to enable a majority of uninsured individuals to afford payment of monthly fee 30. Preferably, monthly fee 30 bears some relationship to the age and/or family status of the member. Preexisting conditions will preferably not result in a denial of membership or refusal of service, as such conditions would likely have to be treated by the same facility in the absence of the present system and method 10. An upper limit per member, however, is preferably provided, wherein if the cost of hospitalization exceeds the upper limit, the individual member will become responsible for the remaining balance. Thus, even individuals in need of treatment for preexisting conditions, and the facilities providing such treatment, can benefit financially from the present system and method 10.

Preferably, each individual member 22 of the plurality of members 20 reviews a listing of member hospitals 40, member pharmacies 60 and member clinics 80. Each individual member 22 preferably selects a treatment hospital 42 from the member hospitals 40, wherein the individual member 22 agrees that hospitalization and other hospital care will only be covered at the selected treatment hospital 42. Thus, although the individual member 22 may visit another hospital for treatment, the associated treatment fee will be billed directly to the individual member 22 in full. If, however, treatment is sought at the selected treatment hospital 42, the individual member 22 preferably receives hospital care at no cost. Although it is preferred that no fees be assessed to individual member 22 at the time treatment is sought, it remains within the scope of the invention described herein that a small processing fee could be collected, or billed, for each visit to the selected treatment hospital 42.

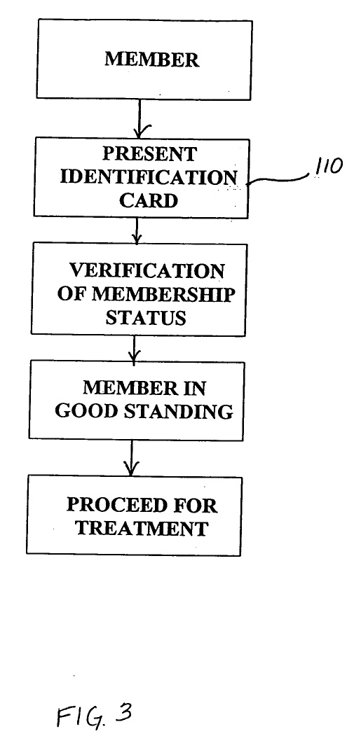

In the preferred embodiment, as depicted in FIG. 3, each individual member 22 receives a membership card 110, wherein possession of a valid membership card 110 provides entitlement to prescription services 70 from any of the member pharmacies 60 and to out-patient, urgent-care, testing, and/or preventative health care procedures available from any of member clinics 80. Again, it is preferred that no fees be assessed to individual member 22 at the time treatment is sought or prescriptions are filled. However, it remains within the scope of the invention described herein that a small processing fee could be collected, or billed, for each filled prescription and/or each visit to a clinic or other outpatient facility, or that such non-hospital services could be separately offered and/or declined under the present system and method 10. In the preferred embodiment, each individual member 22 of plurality of members 20 seeks non-hospital services from any participating clinic 80 and/or pharmacy 60, wherein a selection limitation is preferably not required, unlike the hospital selection/limitation requirement.

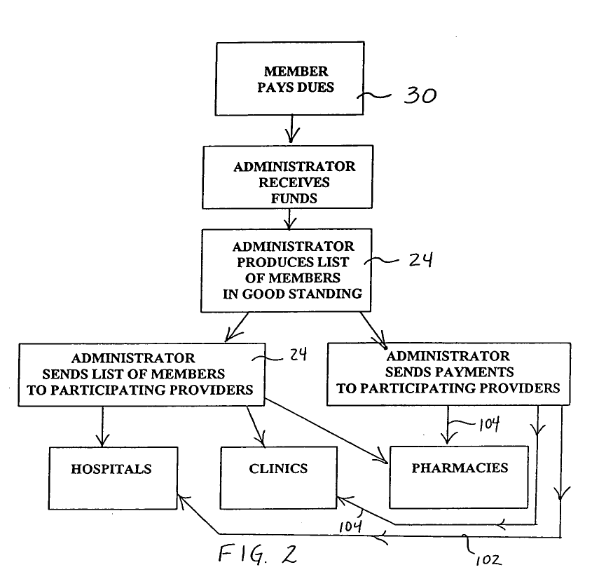

As depicted in FIGS. 1 and 2, plan administrator 15 preferably coordinates and oversees system and method 10. Preferably, each individual of the plurality of individual members 20 remits monthly fee 30 to plan administrator 15. Plan administrator 15 maintains a current listing of members in good standing 24, wherein the listing of members in good standing 24 is provided to each member hospital 40, member pharmacy 60 and/or member pharmacy 60, preferably at frequent intervals. The listing of members in good standing 24 enables each facility to quickly and easily verify the status of each of the plurality of individual members 20. One skilled in the art will readily recognize that in an alternate embodiment, the listing of members in good standing 24 could be provided to participating facilities via telephonic and/or electronic inquiry means, via a global networking system such as the Internet, or via any other means of providing current database-type information to a remote location.

Plan administrator 15 preferably distributes monthly stipend 100 to member hospital 40, member pharmacy 60, and/or member clinic 80. In the preferred embodiment, each member hospital 40 receives a monthly disbursement 102, preferably calculated based upon the number of individual members 20 that have selected the particular member hospital 40 to be the covered hospital treatment center 42. Each member pharmacy 60 and/or member clinic 80 also preferably receives monthly stipend 100 in the form of monthly disbursement 104, preferably calculated based upon the total number of individual members 20 within a given geographic area.

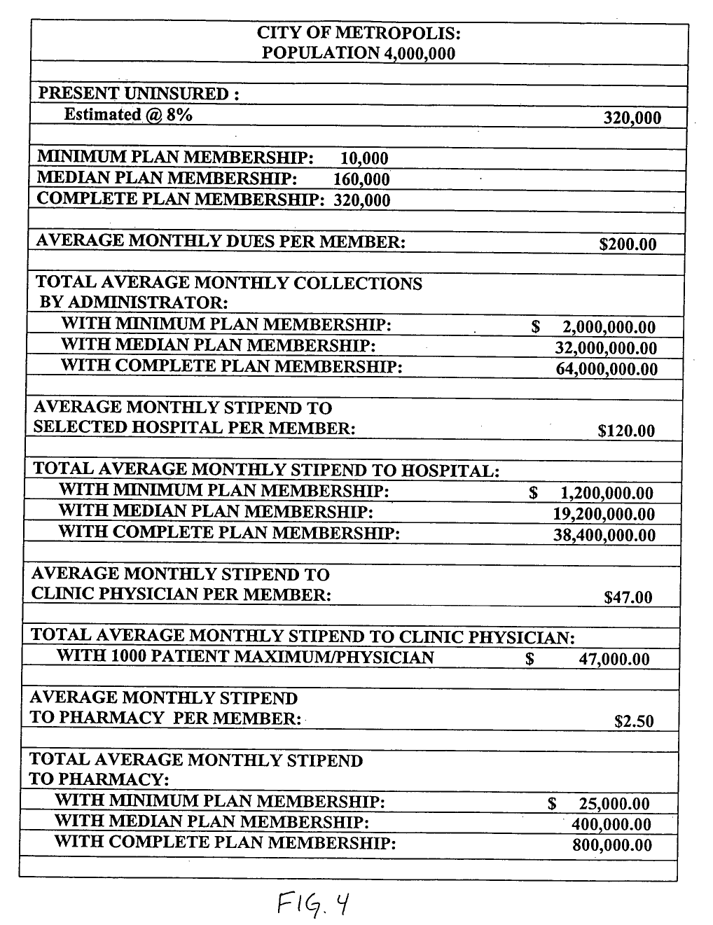

Referring now to FIG. 4, fee 30 and disbursements 102 and 104 are represented with actual values, for exemplary purposes only, to enable a representative financial overview of system and method 10. A fictitious municipality, Metropolis, is offered as an example of a city approximately the size of Atlanta, Ga., U.S.A. In the example, with an eight percent uninsured population, the number of individuals without health insurance would be approximately 320,000. Having no insurance, if five percent of those individuals had to visit a hospital within a given year, there could theoretically be 16,000 unpaid medical bills at the same municipal teaching hospital. Even if each of those medical bills were only $1,000.00, the hospital could potentially be faced with a $16,000,000.00 loss.

If, however, three percent of the uninsured, or one-quarter of one percent of the total population of the fictitious municipality, were to become members of the present system and method 10, preferably known as the HAHALIS PLAN, with average monthly dues per member of $200.00, the hospital could receive a $2,000,000.00 cash inflow each month. If half of the uninsured were to participate, the hospital could receive a consistent $19,200,000.00 per month, and if all of the uninsured were to participate, the hospital could receive $38,400,000.00 per month. Such a tremendous monthly income would be generated from the hospital's agreement to participate in system 10 and to treat the previously uninsured members, wherein the hospital would likely have had to treat those same individuals absent the plan of system 10, but with no compensation.

It is contemplated in an alternate embodiment, system and method 10 could include physician participants practicing at participant clinics, wherein each physician participant would agree to treat a maximum number of members, for example, 1000 members, at a participant clinic, and wherein each physician participant would receive a monthly stipend based upon the number of members under that physician's care for outpatient and/or preventative care. FIG. 4 includes, for representative purposes only, a theoretical calculation for such a provision, wherein a clinic or outpatient physician with 1000 members could receive a stipend of $47,000.00 per month.

In an alternate embodiment that individual members 20 could join system 10 as a part of a larger membership group, wherein the group could oversee membership details and monthly fee disbursements on behalf of the members.

In an alternate embodiment, system and method 10 could include only hospital and physician participants, wherein membership, membership fees and stipends would function for the physician in much the same way as for the hospital.

In an alternate embodiment, system and method 10 could provide membership to individual members 20 in exchange for payment of a membership fee that is assessed, auto-billed and/or auto-withdrawn from a bank, credit card or other type of account.

In an alternate embodiment, system and method 10 could be offered without pharmacy and/or outpatient providers, wherein only hospital care could be provided, operating essentially as a catastrophic plan.

In an alternate embodiment, system and method of providing health care services 10 could offer pharmacy coverage as an add-on, or coverage endorsement, wherein a supplemental fee could be added to the base membership fee, and wherein the member could receive a predetermined discount for pharmacy products and services from member pharmacies.

In an alternate embodiment, system and method 10 could offer out-patient, non-hospital, and/or preventative care coverage as an add-on, or coverage endorsement, wherein a supplemental fee could be added to the base membership fee, and wherein the member could receive a treatment at no charge, could be charged a small fee per visit, or could receive a predetermined discount for treatment from member clinics.

In an alternate embodiment, system and method 10 could include a cap or maximum limitation on treatment or service coverage, wherein such a cap or limitation could be based on number of visits, dollar value, and/or any other reasonable basis.

In an alternate embodiment, system and method 10 could include a per hospital visit fee payable by the member, wherein the fee could be collected upon patient discharge or entry.

In an alternate embodiment, system and method 10 could be structured to enable membership fee 30 to be billed or collected at weekly, biweekly, quarterly, semi-annual or annual intervals.

In an alternate embodiment, system and method 10 could be structured to enable participating facilities to receive stipends at weekly, biweekly, quarterly, semi-annual or annual intervals.

In an alternate embodiment, system and method 10 could include participating private hospitals and/or any other appropriate type of health care service provider.

In an alternate embodiment, system and method 10 preexisting conditions could result in a limitation or cap on selected products or services.

In an alternate embodiment, system and method 10 could be structured to enable each individual member 22 to seek treatment from any member hospital 40, wherein hospital compensation would be calculated based on total membership in lieu of member selection.

In an alternate embodiment, system and method of providing health care services 10 could be structured to require each individual member 22 to select only one pharmacy and/or only one clinic for treatment, wherein each such facility would receive compensation based upon the number of individual members that select that particular facility, in lieu of compensation based on total plan membership.

In an alternate embodiment, membership card 110 could include bar coding, magnetic data, or other type of machine-readable information, wherein member status could be accessed therefrom.

In an alternate embodiment, member status could be available via a secure website, wherein participating facilities could have accessibility thereto.

It should be recognized that system and method 10 and the illustrative steps and/or components thereof could be broken down and/or practiced in a different order, that is, may be executed out of order from that shown or discussed, including substantially concurrently or in reverse order, depending on the functionality involved, as would be understood by those reasonably skilled in the art of the present invention and remain within the scope of the present invention in which functions.

In another alternate embodiment, system and method 10 could be organized and implemented for application in veterinary practice, wherein providers of animal hospitalization and care could be compensated via capitation as described herein.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

1. A method of providing and funding health care services, comprising the steps of:
a) securing at least one hospital care provider, wherein said provider receives a first fee for participating in said method;
b) securing at least one pharmacy service provider, wherein said pharmacy service provider receives a second fee for participating in said method;
c) securing at least one clinical care provider, wherein said clinical care provider receives a third fee for participating in said method;
d) obtaining a plurality of individual members, wherein each said member of said plurality of members pays a fourth fee for participating in said method; and
e) enabling each said member of said plurality of individual members to select one hospital care provider from said at least one hospital care provider, wherein hospital care for said member is provided at said selected hospital care provider,
wherein said first fee to said at least one hospital care provider is based upon the number of said selections from said plurality of individual members for each said hospital care provider, and wherein said second fee to said at least one pharmacy service provider and said third fee to said at least one clinical care provider are based upon the total number of said plurality of members.

2. A method of providing health care services comprising the steps of:
a) enlisting a member hospital;
b) acquiring a plurality of individual members, each individual member of said plurality of members paying a monthly fee;
d) said member hospital offering medical treatment to each said individual of said plurality of individuals, each said member hospital receiving a fixed monthly stipend per each said member of said plurality of members, wherein each said member of said plurality of members receives medical treatment in said member hospital without additional fees.

3. The method of claim 1 further comprising the following steps:
e) enlisting a pharmacy for offering prescription services, said member pharmacy receiving a monthly stipend, each said individual member of each said plurality of individual members receiving prescriptions from said member pharmacy without any additional fees.

4. The method of claim 1 further comprising the following steps:
e) enlisting a clinic for offering preventive care and non-hospitalization services, each said member clinic receiving a monthly stipend; and each said member hospital receiving a fixed monthly stipend per each said member of said plurality of members, wherein each said member of said plurality of members receives medical treatment in said member hospital without additional fees, each said individual member of each said plurality of individual members receives prescriptions from said member clinic without any additional fees.

5. A method for funding a public hospital comprising the steps of:
a) staffing said public hospital with salaried physicians;
b) offering a nominal fee membership for purchase to a plurality of individual members, said membership entitling each said individual member of said plurality of individual members to receive hospital services from said public hospital, wherein each said individual member of said plurality of individual members is otherwise uninsured.

6. A system and method of providing health care services to a plurality of individual members, comprising the steps of:
a) collecting a token fee per individual member;
b) offering treatment for each individual member at a member hospital;
a) offering prescription services for each individual member at a member pharmacy; and
b) offering outpatient care for each individual member at a member clinic; wherein each said member hospital, each said member pharmacy, and each said member clinic receive a predetermined stipend.

7. The system and method of providing health care services of claim 6, wherein said predetermined stipend is monthly.

8. The system and method of providing health care services of claim 6, wherein the frequency of payment of said predetermined stipend is selected from the grouping of weekly, biweekly, quarterly, semi-annual or annual intervals.

9. The system and method of providing health care services of claim 6, wherein each said member hospital is a public facility.

10. The system and method of providing health care services of claim 9, wherein each said member hospital is a teaching hospital.

11. The system and method of providing health care services of claim 6, wherein each said member hospital is a private hospital.

12. The system and method of providing health care services of claim 6, wherein the frequency of collection of said token fee per said individual member is selected from the grouping of weekly, biweekly, monthly, quarterly, semi-annual or annual intervals.

13. The system and method of providing health care services of claim 6, wherein said token fee per said individual member is calculated based upon the age of said individual member.

14. The system and method of providing health care services of claim 6, wherein said token fee per said individual member is calculated based upon the family status of said individual member.

15. The system and method of providing health care services of claim 6, wherein said treatment for each said individual member at said member hospital is subject to a cost maximum, wherein if said treatment exceeds said cost maximum, said member hospital charges said individual member for such excess.

16. The system and method of providing health care services of claim 15, wherein said cost maximum is calculated on an annual basis.

17. The system and method of providing health care services of claim 15, wherein said cost maximum is calculated on a lifetime basis.

18. The system and method of providing health care services of claim 6, wherein each said individual member is charged a per-use fee for each said hospitalization.

19. The method of providing and funding health care services of claim 1, wherein an administrator coordinates and oversees said method of providing and funding health care services, receives fees from said individual members, distributes stipends to said providers, and maintains a current listing of members in good standing, wherein the listing of members in good standing is provided to each said hospital care provider, each said pharmacy provider and each said clinical care provider, at select intervals.

20. The method of providing and funding health care services of claim 1, wherein each said individual member receives a membership card comprising machine-readable information.
